(19) United States
(12) Patent Application Publication
(10) Pub. No.: US 2011/0121647 A1
(43) Pub. Date: May 26, 2011

(54) SOLAR POWER DISTRIBUTION SYSTEM

(75) Inventor: Chris J. Ragavanis, Old Saybrook, CT (US)

(73) Assignee: RENEWABLE ENERGY SOLUTION SYSTEMS, INC., Lake Mary, FL (US)

(21) Appl. No.: 12/887,321

(22) Filed: Sep. 21, 2010

Related U.S. Application Data
(60) Provisional application No. 61/244,290, filed on Sep. 21, 2009.

(51) Int. Cl. H02J 3/38; H02J 1/00; H02J 1/10; H02J 3/00

(52) U.S. Cl. 307/19; 307/71; 307/18; 307/82

(57) ABSTRACT

The present invention is directed toward a solar power system including an array of photovoltaic panels. The photovoltaic array may include a first module electrically coupled to an AC load and a second module electrically coupled to a DC load. The array may be reconfigured such that individual panels may be transferred from the first module to the second module, and vice versa. The arrays may generate power that is selectively distributed to direct current and alternating current power loads. The system further includes a power management device effective to maximize the power generation of the second module.

### FIELD OF THE INVENTION

The present invention relates to a solar power generation system and, in particular, to a system configured to maximize the energy efficiency of a direct current power distribution plant supported by solar power.

### BACKGROUND OF THE INVENTION

Direct current (DC) power distribution plants include power systems that generally employ rectifiers that generate a direct current (DC) voltage from an alternating current (AC) power source. Distribution modules include circuit breakers that connect the rectifiers to loads and that distribute current to the loads. The loads typically include transmitter and receiver circuitry, telephone switches, cellular equipment, routers and other associated equipment. Many DC power distribution plants include cabinets that with, e.g., temperature compensation devices that increase and decrease the cabinets' inner temperature to lengthen the life of instruments, as well as to prevent thermal runaway. In the event that AC power is lost, the DC power management system typically utilizes backup batteries and/or generators to provide power.

Solar power is a clean and renewable source of energy that has mass market appeal. Among its many uses, solar power can be used to convert the energy from the sun either directly. The photovoltaic cell is a device for converting sunlight energy directly into electricity. When photovoltaic cells are used in this manner, they are typically referred to as solar cells. A solar cell array or module is simply a group of solar cells electrically connected and packaged together. The recent, increased interest in renewable energy has led to increased research in systems for distributed generation of energy. Various topologies have been proposed for connecting these power sources to the load, taking into consideration various parameters, such as voltage/current requirements, operating conditions, reliability, safety, costs, etc.

Connecting photovoltaic panels to the power system of the DC power distribution plant presents power efficiency challenges. In conventional applications, power generated by the photovoltaic panels is inverted from direct current (DC) to alternating current (AC), and then (through the use of the rectifier) introduced as direct current back into a power management cabinet. Due to the variable voltages produced by photovoltaic panels, this traditional method of inverting DC to AC and then back to DC presents extensive losses in DC plant applications. Specifically, systems used in these applications are generally inefficient because of constant heat losses occurred during transitions from DC to AC, and then back to DC.

Thus, it would be desirable to provide a solar power distribution system that has increased efficiency over conventional systems.

### SUMMARY OF THE INVENTION

The present invention is directed toward a power system for direct current (DC) power management system. The system includes an array of photovoltaic panels electrically coupled to an electrical load. In one embodiment, the photovoltaic array may be divided into modules that selectively generate power for alternating current (AC) and/or direct current (DC) loads. Specifically, the photovoltaic array is divided into a first module that generates/directs power toward the AC side of the system and a second module that generates/directs power toward the DC side of the system. The array may be selectively reconfigured such that individual panels may be transferred from the first module to the second module, and vice versa.

In another embodiment, the system includes a PV array electrically coupled to a power management device configured to condition the variable voltage generated by the array. Specifically, the power management device may be coupled to the DC-DC converter that supplies the DC load. The power management device is configured to continuously monitor the input and output voltages of the converter, maximizing the operational range of the converter thereby increasing the energy efficiency of the system.

### BRIEF DESCRIPTION OF THE DRAWINGS

FIGS. 1A and 1B are schematic diagrams for a solar power distribution system in accordance with an embodiment of the present invention.

FIG. 2A is the solar power distribution system of FIG. 1A further including a power management device.

FIG. 2B is a schematic diagrams for a solar power generation system further including a power storage device.

FIG. 3 is a schematic diagram for a solar power generation system including a power management device in accordance with another embodiment of the invention.

FIG. 4 illustrates the electrical diagram of the power management circuit in accordance with an embodiment of the invention electrically coupled to one or more DC-DC converters.

FIG. 5 illustrates a flow chart showing the control logic of the circuit in accordance with an embodiment of the invention.

Like reference numerals have been used to identify like elements throughout this disclosure.

### DETAILED DESCRIPTION OF THE INVENTION

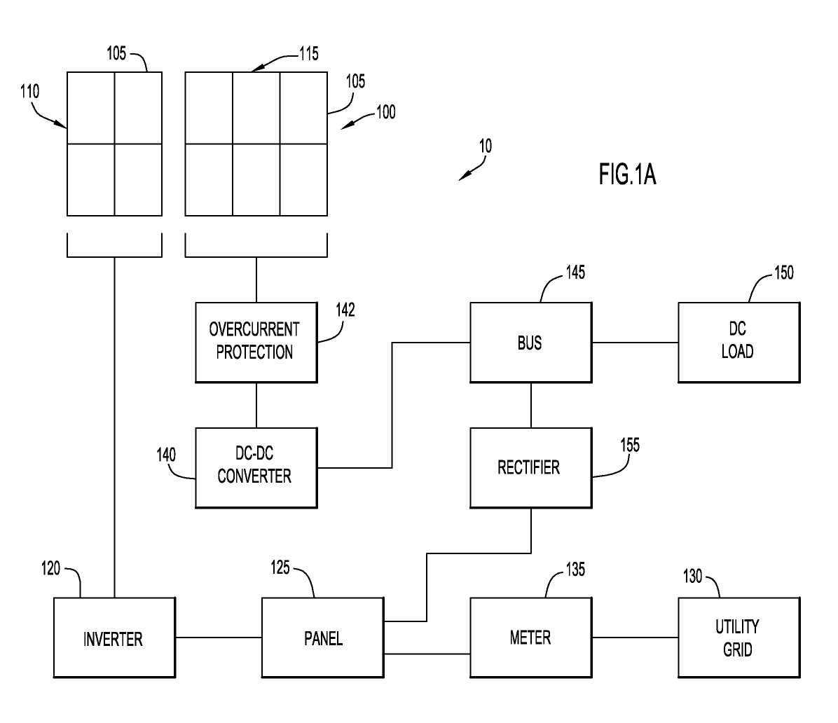

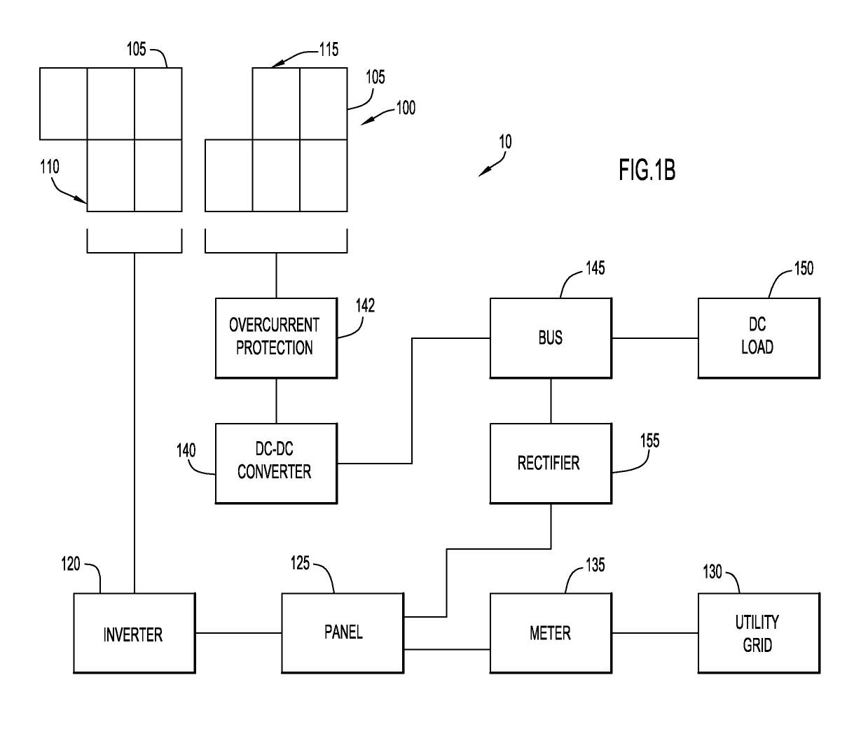

FIGS. 1A and 1B illustrate a direct current (DC) power management system 100 supported by solar power in accordance with an embodiment of the invention. The DC power management system may be implemented in any DC plant including. By way of example, the DC power management system may be utilized within a telecommunications site operable to facilitate wireless network access. For example, the site may be a telecommunications tower, a telephony base station, a wireless network access base station, a wireless email base station, and/or the like. By way of further example, the cell site may be operated by a mobile telephony service provider. Generally, cell site is configured to provide a network interface for mobile devices. The cell site and mobile devices may communicate using any wireless protocol or standard. These include, for example, Global System for Mobile Communications (GSM), Time Division Multiple Access (TDMA), Code Division Multiple Access (CDMA), Orthogonal Frequency Division Multiple Access (OFDM), General Packet Radio Service (GPRS), Enhanced Data GSM Environment (EDGE), Advanced Mobile Phone System (AMPS), Worldwide Interoperability for Microwave Access (WiMAX), Universal Mobile Telecommunications System (UMTS), Evolution-Data Optimized (EVDO), Long Term Evolution (LTE), Ultra Mobile Broadband (UMB), and/or the like.

The power distribution system 20 includes a photovoltaic (PV) array 100 including one or more photovoltaic panels 105 (e.g., including, but not limited to, 305 watt monocrystalline photovoltaic panels). Specifically, the array 100 includes a first sub-array or module 110 and a second sub-array or module 115. The first module 110 may include one or more photovoltaic panels 105 connected, e.g., in series. The first module 110 is in electrical communication with an inverter 120 that converts the fluctuating direct-current (DC) into alternating current (AC) having a desired voltage and frequency (e.g., 110V or 220V at 60 Hz, or 220V at 50 Hz).

The inverter 120, in turn, is in communication with a panel 125. By way of example, the panel 125 may be a telecommunications cabinet or electrical panel electrically coupled to one or more devices that accommodate an AC load. For example, the panel 125 may include one or more devices requiring alternating current such as lights, air conditioning, etc. The system 10 is configured such that the AC devices draw its power from the first module 110 or, when sufficient power from the first sub-array is not available, from the utility power grid 130. In this manner, the first module 110 feeds the “AC side” of the system.

In addition, any power not utilized by the AC devices may be directed either toward the DC load (via rectifier 155) or back to the utility power grid 130 (the flow of which is tracked by an electrical meter 135).

The second module 115 includes one or more photovoltaic panels 105 connected, e.g., in parallel. The second module 115 may be electrically coupled to a device requiring a direct current via one or more DC-DC converters 140 (e.g., a 1200 watt DC-DC converter module). An over-current protection device 142 may be disposed between the second module 115 and the converter 140. The DC-DC converter 140 is configured to convert the direct current generated by the second module 115 from one voltage level to another. The modified voltage is then directed to the electrical bus 145, which is electrically coupled to the DC load 150 (i.e., the devices accommodating a DC load). In this manner, the second module 115 feeds the “DC side” of the system 10.

In one embodiment, the electrical bus 145 may further be electrically coupled to the panel 125 via a rectifier 155 operable to convert alternating direct current to direct current. Thus, should the second module 115 generate insufficient to power the DC load (e.g., during a period of darkness), the system 10 will draw energy from the utility power grid 130 to supply the DC load.

As noted above, the photovoltaic array 100 includes one or more photovoltaic panels 105. Since the voltage generated by a single solar panel 105 is low, a plurality of panels is typically connected together to increase the amount of generated voltage. The number of photovoltaic panels 105 forming the array 100 is not particularly limited. By way of example, the photovoltaic array 100 may include 10 panels 105. The panels 105 may be connected in series in order to achieve a desired voltage value or in parallel in order to reach a desired current value. In the embodiment illustrated, the panels 105 of the first module 110 are connected in series, while the panels of the second module 115 are connected in parallel.

The number of panels 105 forming each module 110, 115, moreover, may be selectively reconfigured to direct the desired amount of power toward the “DC side” of the system or the “AC side” of the system 10. Thus, as shown in FIG. 1A, the 10-panel system 10 may be configured such that the power source for the AC side of the system (the first module 110) is formed by four panels 105 connected in series, while the power source for the DC side of the system (the second module 115) includes six panels connected in parallel. Alternatively, the 10-panel system may be reconfigured as illustrated in FIG. 1B, with the power source for the AC side including five panels 105 connected in series, while the power source for the DC side including five panels connected in parallel. In other embodiments, the entire array 100 may be directed toward to the DC side of the system.

The system 10, then, provides a dual voltage system for a dc plant that is selectively reconfigurable based on the needs of the system. Table I includes exemplary configurations of a 10-panel system based in the power needs of the AC and DC loads associated with a 20 DC amp panel 125. It should be understood that other configurations may be utilized depending on the number of panels, the amperage requirements of each panel, the voltage requirements of the system, and other parameters.

TABLE 1

| | | | NUMBER | NUMBER |
|---|---|---|---|---|
| | | | OF | OF |
| | | | PANELS | PANELS |
| | | | AC | DC |
| TOTAL | NUMBER | | SIDE (TO | SIDE (TO |
| NUMBER OF | OF | | POWER | POWER |
| PHOTOVOLTAIC | SYSTEM | | AC | DC |
| PANELS | PANELS | VOLTAGE | LOAD) | LOAD) |
| 10 | 1 (20 amps) | 24 | 8 | 2 |
| 10 | 2 (40 amps) | 24 | 6 | 4 |
| 10 | 3 (60 amps) | 24 | 5 | 5 |
| 10 | 1 (20 amps) | 48 | 6 | 4 |
| 10 | 2 (40 amps) | 48 | 3 | 7 |
| 10 | 3 (60 amps) | 48 | 0 | 10 |

In operation, a photovoltaic array 100 having a predetermined number of panels 105 may be associated with a site having at least DC load requirements (or both DC load and AC load requirements). The DC load for the site is calculated, and the proper DC configuration is determined. The calculation identifies the number of panels 105 needed from the array 100 to be placed in the second module 115 (the DC module). Any remaining panels 105 in the array 100 are then connected in the first module 110 (the AC module), with the voltage from the first module 110 being directed into the panel 125.

With this configuration, the DC load with the system is substantially powered by the second module 115. As a result, the system is configured such that, with proper environmental conditions (sufficient sunlight), the rectifier 155 will be placed into hibernation. The excess AC power introduced from the first module is now available to supplement the AC load of the system. In the case of a non-existent AC load, the excess electrical current will be introduced back to the local utility grid. This significantly improves the electrical efficiency of the site and its cost of operation.

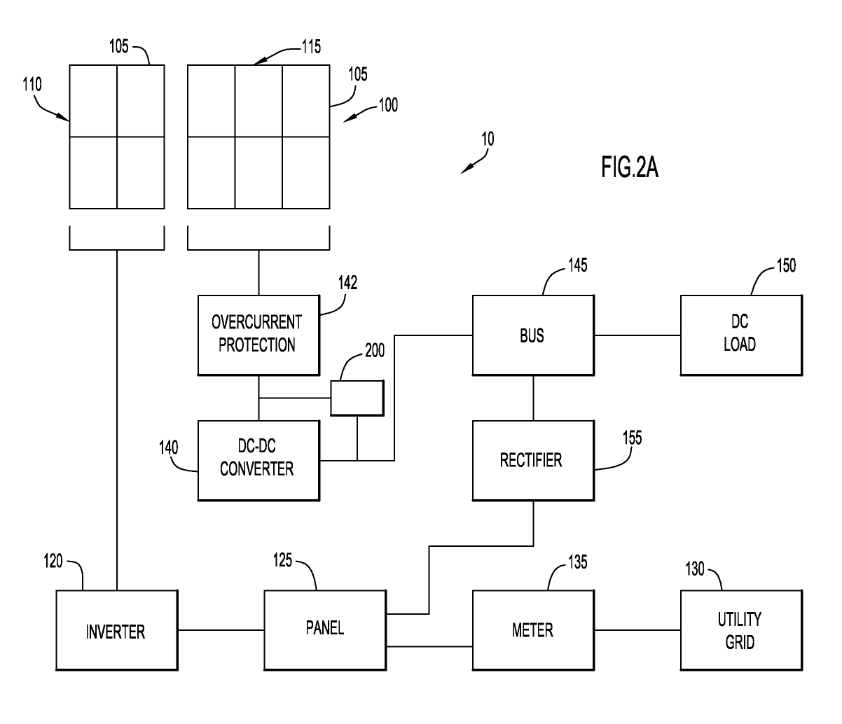

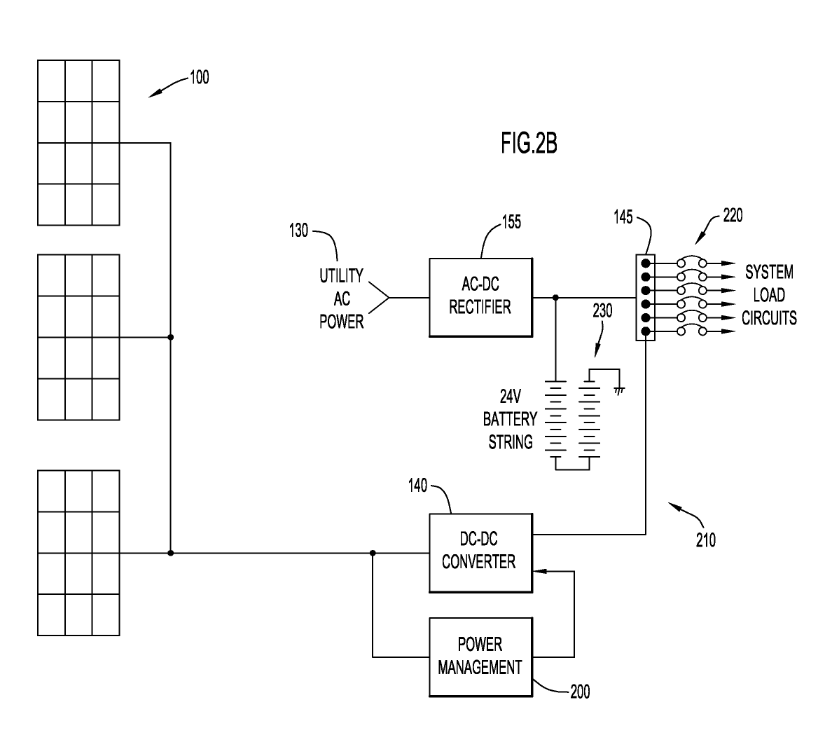

One embodiment is directed toward a DC power management system a power management device that increases the operational range of the system. Referring to the embodiment shown in FIG. 2A, the system 10 includes a DC power management device 200 electrically coupled the DC-DC converter 140. The DC power management device 200 is configured to monitor voltage entering the converter from the second module 115 (discussed in greater detail below).

As shown in FIG. 2B, the DC power distribution system 210 may further include a power storage device operable to store energy for later use in no light or no grid conditions. Specifically, the system 210 includes the photovoltaic (PV) array 100 electrically coupled to the DC load 220 via a DC-DC converter assembly including a plurality of DC converters 140 with the power management device 200 electrically coupled thereto. The DC load 220 is further connected to the utility power grid 130 via the AC-DC rectifier 155. The power storage device 230, disposed between the AC-DC rectifier 155 and the load devices 220, may be a battery plant such as a 24V battery string.

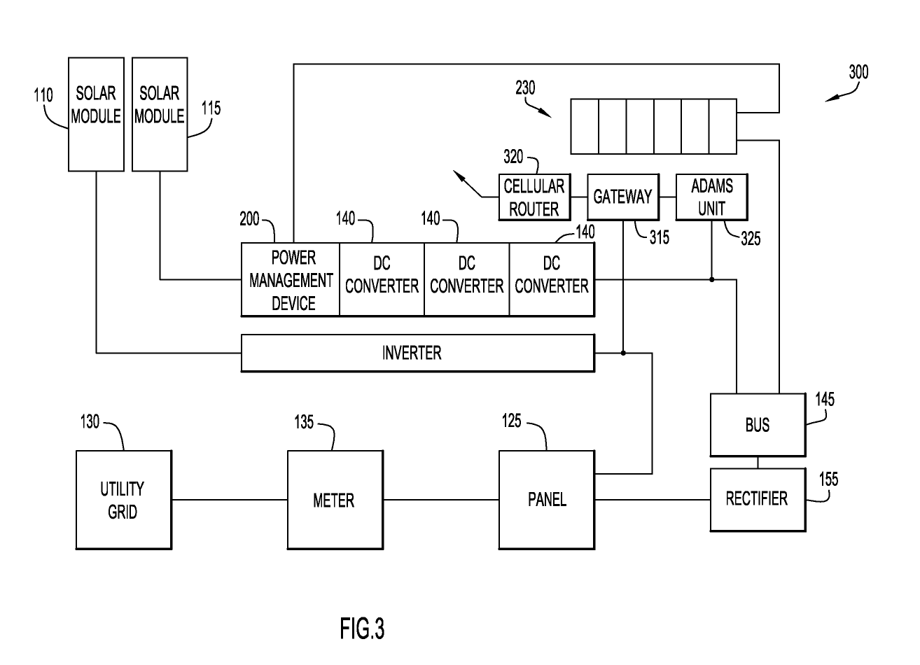

Similarly, in the embodiment shown in FIG. 3, the DC power distribution system 310 includes the photovoltaic (PV) panel array 100 including a first module 110 and a second module 115 as described above. (FIG. 1) The second module 115 is electrically coupled to one or more DC converters 140 via the DC power management device 200. The system 310 further includes a power storage device 230 (e.g., a battery plant such as a 24V battery string) that provides power during grid outages. Each of the utility power grid 130 and the power storage device 230 are electrically coupled to the AC load source 125.

When the DC load site is a telecommunications site, the site may further include conventional wireless carrier components such as a gateway 315 electrically coupled to the AC side of the system. The gateway 315 may further be in communication with a cellular router 320 and Adams unit 325.

The DC-DC converter 140 in each of the above systems 10, 210, 310 provides proper voltage matching and power control by regulating output power in the presence of input voltage variations. In one embodiment, the DC-DC converter 140 is set to operate when the input voltage falls within a range of 34V to 60V. For input voltages below or above this range, the DC-DC converter 140 automatically shuts down. When the voltage from the second module of the photovoltaic panel array 100 is at a level where the DC-DC converter 140 draws less power than is available from the array 100, the DC-DC converter 140 will disengage, no longer generating output voltage. Similarly, at input voltages where the PV array 100 cannot provide sufficient power to satisfy the demand, the DC-DC converter 140 shuts down.

As a result, when utilizing photovoltaic panels 105 with an active converter load, care must be taken to assure the output characteristics of the PV array 100 and the input characteristics of the DC-DC converter 140 produce the desired effects. As the amount of sunlight is reduced, or as temperature increases, the amount of available power entering the converter 140 will decrease. In addition, if output power demand stays high, but available sunlight goes down, at some point, the peak power that the PV array 100 is able to supply will not meet the minimum threshold voltage of the DC-DC converter. When this happens, the output voltage of the PV array 100 will very quickly fall off to the point where the DC-DC converter 140 will shut down. Under these conditions, the system 10, 210, 310 will enter a mode in which the DC-DC converter 140 overloads the PV array 100, causing the input voltage to collapse, which, in turn, causes the DC-DC converter 140 to shut down. Since the PV array 100 has no load, the input voltage then jumps, the DC-DC converter 140 restarts, and the array voltage collapses. This process continues, resulting in a dramatic reduction in power delivered to the load site (e.g., telecommunications cabinet and/or the telecommunications plant load), as well as in a dramatic reduction in electrical/system efficiency.

In order to prevent this type of occurrence, the DC power management device 200 is utilized maximize the efficiency of the system by maximizing the power usage of the energy generated by PV array 100. Specifically, power management device 200 is configured to maintain the output voltage of the DC-DC converter 140 within predetermined parameters, automatically adjusting when the voltage input of the converter diminishes (which typically occurs when sunlight decreases). In general, photovoltaic panels 105 have a single operating point where the values of the current (I) and Voltage (V) of the cell result in a maximum power output. These values correspond to a particular load resistance. A photovoltaic panel has an exponential relationship between current and voltage, and the maximum power point occurs at the knee of the curve, where the resistance is equal to the negative of the differential resistance. With this knowledge, a power management circuit may be utilized to extract the maximum power available from a panel, and in particular, the panel array 100.

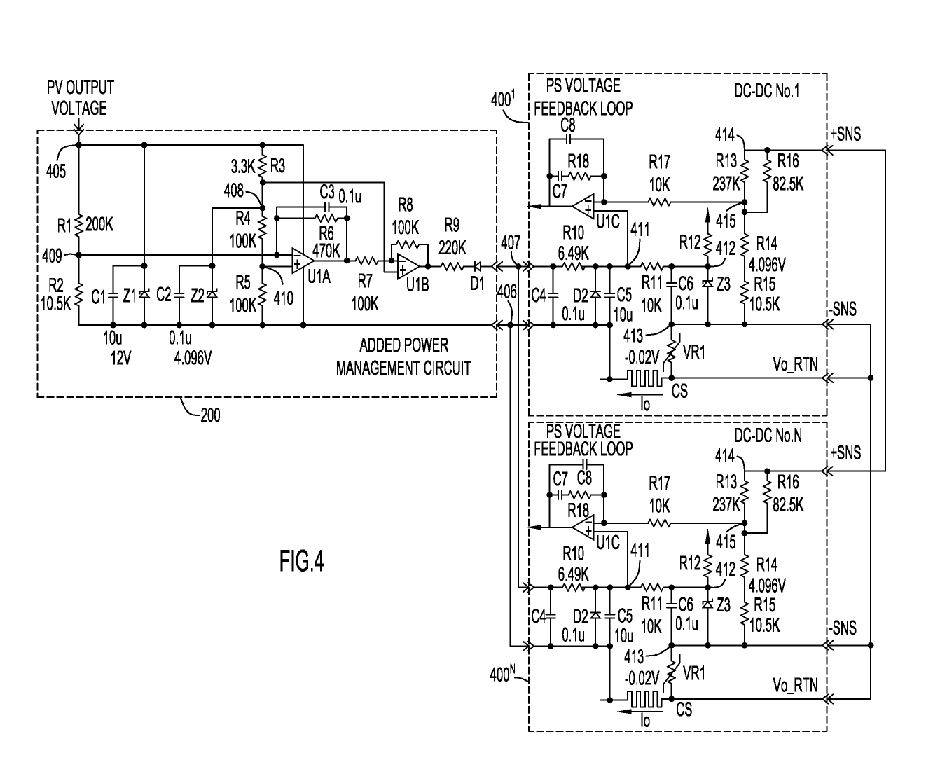

FIG. 4 is a circuit diagram illustrating an example of circuitry for implementing DC power management device 200 and DC-DC power converter 140. The DC-DC power converter 140 can be implemented with one or more interconnected DC-DC power converter circuits 400ᵢ (i=1 to N, where N is at least one). It will be appreciated that the specific characteristic values of the circuit components described (e.g., resistances, capacitances, voltages, etc.) are examples only, and the invention is not limited to these particular characteristic values. Power management device 200 receives voltage from photovoltaic array 100 at an input node 405. Resistors R1 (200 KΩ) and R2 (10.5 KΩ) are connected in series between input node 405 and a first output node 406 along a first path. Resistors R3 (3.3 KΩ), R4 (100 KΩ), and R5 (100 KΩ) are connected in series between input node 405 and first output node 406 along a second path parallel to the first path. A capacitor C1 (10 μF) is connected between input node 405 and first output node 406 in parallel with the first and second paths, and a Zener diode Z1 also is connected between input node 405 and first output node 406 in parallel with the first and second paths (i.e., in parallel with capacitor C1). A capacitor C2 (0.1 μF) and a Zener diode Z2 are connected in parallel between the first output node 406 and a node 408 between resistors R3 and R4.

A node 409 between resistors R1 and R2 supplies an input signal to the inverting (negative) input of a first differential or operational amplifier U1A, and a node 410 between resistors R4 and R5 supplies an input signal to the non-inverting (positive) input of first amplifier U1A. The positive and negative power supplies of first amplifier U1A are connected to input and output nodes 405 and 406 of power management device 200, respectively. A resistor R6 (470 KΩ) and capacitor C3 (0.1 μF) are connected in parallel between the output and the negative input of first amplifier U1A.

The output of first amplifier U1A is coupled to the negative input of a second differential amplifier or op amp U1B via a resistor R7 (100 KΩ). Node 408 supplies an input signal to the positive input of second amplifier U1B, and a resistor R8 (100 KΩ) is connected between the output and negative input of second amplifier U1B. The output of second amplifier U1B is coupled to a second output node 407 of power management device 200 via a resistor R9 (200Ω) and diode D1 connected in series.

As noted above, the DC power management device 200 is electrically coupled to each of the one or more DC-DC converter circuits 400ᵢ (i=1 to N). In particular, first and second output nodes 406 and 407 from DC power management device 200 respectively serve as first and second input nodes to each DC-DC converter circuit 400ᵢ. Within each DC-DC converter circuit 400ᵢ, a capacitor C4 (0.1 μF) is connected across the input nodes 406 and 407. Input node 407 is connected to a node 411 via a resistor R10 (6.49 KΩ). Node 411 is coupled to input node 406 via a diode D2 and a capacitor C5 (10 μF) connected in parallel. Node 411 is also connected to a node 412 via a resistor R11 (10 KΩ). Node 412 is connected to a positive power supply via a resistor R12 and is connected to a further node 413 via a capacitor C6 (0.1 μF) and a Zener diode Z3 connected in parallel. One end of a current source CS, providing a current I₀, is connected to node 413 via a variable resistor VR1. The other end of current source CS is connected to input node 406.

Resistors R13 (237 KΩ), R14 and R15 (10.5 KΩ) are connected in series between a node 414 and node 413. A resistor R16 (82.5 KΩ) is connected between node 414 and a node 415 between resistors R13 and R14 (i.e., resistor R16 is arranged in parallel with resistor R13). Note that the nodes 413 of the respective DC-DC converter circuits 400ᵢ are coupled to each other. Likewise, the nodes 414 of the respective DC-DC converter circuits 400ᵢ are coupled to each other. Finally, the current sources C5 of the respective DC-DC converter circuits 400ᵢ are coupled to each other at the end coupled to the variable resistors VR1.

A PS Voltage Feedback loop includes a differential or operational amplifier U1C having its positive input coupled to node 411 and its negative input coupled to node 415 via a resistor R17 (10 KΩ). The negative input and the output of amplifier U1C are connected via a resistor R18 and a capacitor C7 connected in series. A capacitor C8 is connected in parallel across capacitor C7 and resistor R18.

The maximum power that can be delivered by the PV array is a function of temperature and irradiance. To harvest maximum power from the PV array under varying operating conditions, the output voltage of the DC-DC converter 140 must be set to the “knee” of the PV array's power versus voltage curve (as explained above). The power management circuit 400 is configured to monitor the input voltage of the converter 140 (i.e., the output voltage of the PV array, decreasing the output of the DC-DC converter 140 if the voltage of the PV array falls below a predetermined value (e.g., 45V). In other words, the circuit is configured to maintain the output voltage of the DC-DC converter 140 at it maximum power point (along the knee of the power vs. voltage curve of the PV array 100). With this configuration, the circuit 400 prevents the severe reduction of PV array output power that occurs when the DC-DC under voltage lockout circuit is activated.

In one embodiment, the output voltage of the PV array will fall off at a rate of −0.1766V/° C., providing a minimum usable voltage of approximately 45V at temperatures up to 65° C. (or 150° F.). When full sun conditions are available, the DC-DC converter 140 will operate from a PV array no load voltage of approximately 61V up to a full load voltage of approximately 55V. If along this trajectory, it is observed that PV array voltage begins to decrease at a faster rate for increasing output power, output power will be decreased until the slower trajectory is re-established.

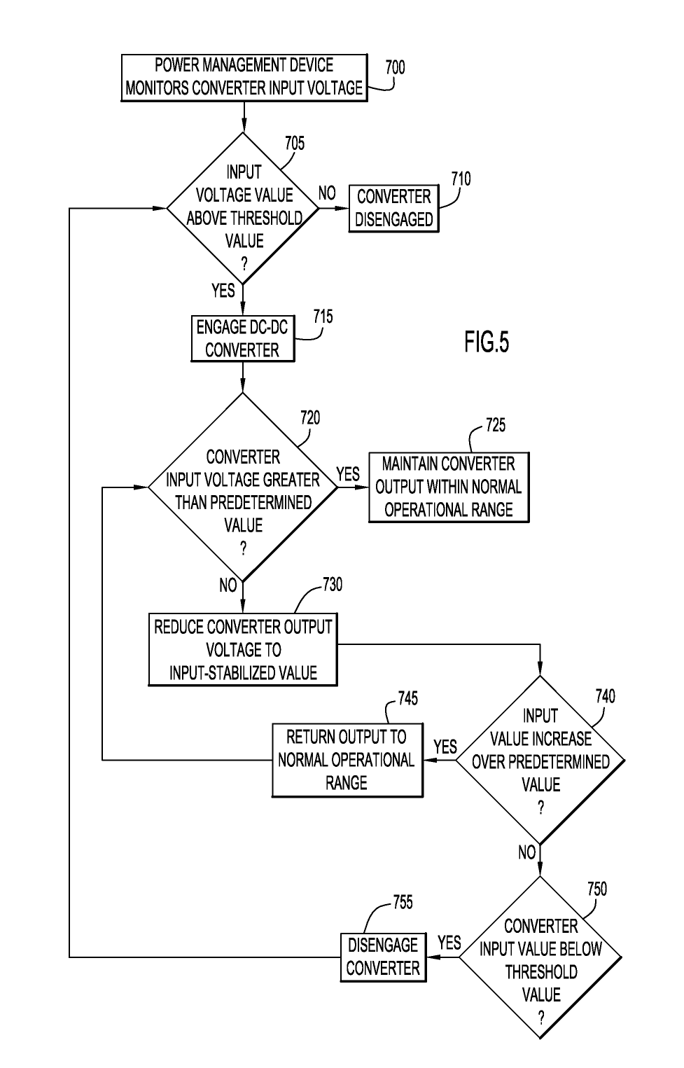

FIG. 5 is a flow chart explaining the operation of the power management circuit 400. With the converter 140 beginning in its disengaged (“off”) state, the power management circuit 400 monitors the PV array voltage (Step 705). The power management circuit 400 queries the input voltage (i.e., the output voltage of the PV array) to determine if the voltage is greater than a minimum threshold value (e.g., 34V DC) (Step 710). If not, the converter 140 remains disengaged. If, however, the input voltage is greater than the threshold value, then the circuit 140 engages the DC-DC converter 140 (Step 715).

The circuit 400 continues to monitor the input voltage determining whether the input voltage is above a predetermined value (e.g., 45 V) (Step 720). If the input voltage measure is above the predetermined value, the converter 140 operates normally, generating output in a normal operational range (e.g., 55-64 V) (Step 725). If, however, the input voltage falls below the predetermined value (45 V), but is still above the minimum threshold value (34 V), then the DC power management circuit 400 reduces the output voltage of the DC-DC converter 140 until the input voltage is stabilized (Step 730). For example, in a system having a normal operational voltage of 55V-64V, rather than shutting down, the converter will simply generate output at a value that falls below the normal operational range to maximize the amount of energy drawn from the PV array.

The circuit 400 continues to monitor the converter input voltage (Step 740). If PV array voltage increases or DC-DC demand power decreases, then the circuit 400 returns the converter output to a value falling within the normal operating range (e.g., 55-64V DC) (Step 745). Should, however, the input voltage decrease below the minimum threshold value (Step 750), the circuit 400 will shut down the DC-DC converter 140 (Step 755). Once the input voltage increases to a value above the threshold value, the circuit re-initiates the DC-DC converter, continuing the process.

The above system provides a DC power management system supported by a variable power source such as a solar power array. The system provides a renewable energy process that drastically reduces the power consumption of the site. Due to the variable voltages produced by photovoltaic panels, the traditional mechanism of inverting the direct current to alternating current and then, through the use of a rectifier, introduce DC voltage back into the system is impractical for certain applications. (such as cell sites). This traditional mechanism has low efficiency because of constant heat losses occurred during transitions from DC to AC, then back to DC. The inventive system and process, however, utilizes the power produced from the photovoltaic array 100 and delivers compatible power directly to the DC load without inversion. This improves the efficiency of the site.

The DC power management circuit 400 is effective to increase the available “input range” of the DC-DC converter 140 to engage system components at the first detection of UV light at sunrise hours. This will begin the flow of power to the DC load incrementally, and build as more sun is detected. In addition, the DC power management 400 circuit adjusts the output voltage of the converter to 0.4V DC 0.6V DC above the battery float voltage. This ensures the photovoltaic array 100 operates as the primary source of power during daylight hours, as well as during grid loss.

The DC power management system may be introduced or shut down as conditions warrant. Its introduction at sunrise and its retreat at sunset can be transparent to existing equipment. Failsafe protections may be installed—in the unlikely event of failure, our system simply shuts down and lays idle. The system remains usable during and after natural disasters or acts of terrorism. The system can be customized to suit all types of international voltage ranges and certifications, and comes equipped with the ability to expand for use at night during these crucial times. The power management circuit provides a logical fail-safe function where the circuit reintroduces grid power during cloud cover, foul weather and nighttime hours. During grid loss situations, it would act the same, but working intermittently with system batteries instead of the utility grid.

While the invention has been described in detail and with reference to specific embodiments thereof, it will be apparent to one skilled in the art that various changes and modifications can be made therein without departing from the spirit and scope thereof. For example, the DC power management system may be utilized in any electrical plant supported by solar energy including, but not limited to, wireless communication sites. Such plants may include any number of current transformers, DC capacitors, and/or over current protection devices as warranted. The DC-DC converter may be configured to generate output voltages within a predetermined range, and may be selected to correspond to the float voltage of the power storage device.

It is intended that the present invention cover the modifications and variations of this invention that come within the scope of the appended claims and their equivalents.

What is claimed is:

1. A solar power distribution system for a cellular communication site, the system comprising:
a photovoltaic array operable to generate direct current (DC), the array including:
a first module comprising a first plurality of photovoltaic panels, and
a second module comprising a second plurality of photovoltaic panels;
an inverter in communication with the first module, the inverter being operable to convert the direct current into alternating current (AC); and
a DC-DC converter in communication with the second module, the DC-DC converter operable to convert the voltage level of the direct current,
wherein the photovoltaic array is reconfigurable such that the photovoltaic panels of the first module may be electrically coupled to the photovoltaic panels of the second module, and vice versa.

2. The solar power distribution system of claim 1, wherein:
the photovoltaic panels of the first module are connected in series; and
the photovoltaic panels of the second module are connected in parallel.

3. The solar power distribution system of claim 2, wherein:
the system further includes an AC load device; and
the first module generates power to power the AC load device.

4. The solar power distribution system of claim 1, wherein:
the DC-DC converter receives an input voltage from the second module and transmits an output voltage toward a DC load device;
the system further comprises a power management device electrically coupled to the DC-DC converter; and
the power management device monitors input and output voltages of the converter to selectively adjusts converter output voltage based upon converter input voltage.

5. A solar power system for a cellular communication site, the system comprising:
a solar array including:
a first module configured to direct power toward an AC load; and
a second module separate from the first module, wherein the second module is configured to direct power toward a DC load;
a DC-DC converter in electrically communication with the first module, wherein the converter has an input voltage provided by the first module of the solar array and an output voltage directed toward the DC load, and wherein the converter possesses a minimum threshold value at which the operation of the converter ceases; and
a power management device electrically coupled to the DC-DC converter,
wherein the power management device selectively adjusts the output voltage of the DC converter to maintain the output voltage above a minimum threshold value.

6. The cell site solar power system of claim 5, wherein:
the first module of the solar array comprises photovoltaic panels connected in series;
the second module of the solar array comprises photovoltaic panels connected in parallel.

7. The cell site solar power system of claim 6, wherein the first module of the solar array is electrically coupled to an inverter.

8. The cell site solar power system of claim 5 further comprising a power storage device electrically coupled to the solar array.

9. A method of reconfiguring the power output of a power distribution system for a cell site, the method comprising:
(a) obtaining a power distribution system including:
a photovoltaic array operable to generate direct current (DC), the array comprising:
a first module including a first plurality of photovoltaic panels,
a second module including a second plurality of photovoltaic panels,
an inverter operable to convert the direct current into alternating current (AC), and
a DC-DC converter operable to convert the voltage level of the direct current;
(b) designating a predetermined number of total panels to define the photovoltaic array;
(c) designating a first portion of the total panels to form the first module;
(d) designating a second portion of the total panels to form the second sub-array;
(e) electrically coupling the first module to the inverter;
(f) electrically coupling the second module to the DC-DC converter; and
(g) directing power generated by the second module directly to a DC load device.

10. The method of claim 9 further comprising (h) disconnecting at least one photovoltaic panel from the first module and connecting the panel to the second module.

11. The method of claim 9, wherein:
the DC-DC converter receives an input voltage from the second module and generates an output voltage toward the DC load device; and
the system further comprises a power management device operable to selectively vary converter output voltage based upon measured converter input voltage.
